(19) United States
(12) Patent Application Publication
(10) Pub. No.: US 2003/0072545 A1
(43) Pub. Date: Apr. 17, 2003

(54) Drop cable and method of fabricating same

(75) Inventors: Masahiro Kusakari, Chiba (JP); Kazunaga Kobayashi, Chiba (JP); Shimei Tanaka, Chiba (JP); Hirohito Watanabe, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: FUJIKURA LTD., Tokyo (JP)

(21) Appl. No.: 10/212,735

(22) Filed: Aug. 7, 2002

(30) Foreign Application Priority Data
Oct. 12, 2001 (JP) 2001-315648
Oct. 18, 2001 (JP) 2001-320452
Oct. 23, 2001 (JP) 2001-325513
Dec. 11, 2001 (JP) 2001-376977

(51) Int. Cl. G02B 6/44

(52) U.S. Cl. 385/101; 385/102

(57) ABSTRACT

A method for fabricating a drop cable includes the step of providing a strength member including a yarn including a non-conductive and tensile strength fiber. The method includes the step of arranging a core including an optical fiber side-by-side the strength member. The method includes the step of arranging a messenger wire side-by-side the core. The method includes the step of extruding the strength member, the core, and the messenger wire together for sheathing.

### BACKGROUND OF THE INVENTION

1. Field of the Invention

The present invention relates to a drop cable and a method of fabricating the same.

2. Description of the Related Art

Heretofore, in order to realize the FTTH (Fiber to the Home), that is, in order to make it possible to transmit or receive high-speed broadband information such as ultra high-speed data at homes and offices, an optical fiber cable extended from a telephone office has been dropped to a subscriber's house such as a general house. For wiring this optical fiber cable, a drop cable has been used. The drop cable (outside wire) is a cable used to drop the optical fiber cable into the home from a utility pole.

This kind of the drop cable is disclosed in Japanese Patent Laid-Open No. 2001-83385.

This drop cable includes an optical fiber core or an optical fiber tape core. This drop cable includes strength members, which are made of a pair of conductive metal wires such as steel wires and added to both sides of the core. The core and the strength members are collectively coated with a sheath made of thermoplastic resin to form an optical element portion. The drop cable includes metal wires, for example, messenger wires made of steel wires. The messenger wires are coated with the thermoplastic resin sheath to form a cable support portion. The optical element portion and the support portion are integrally connected parallel with each other with a constricted neck interposed therebetween.

### SUMMARY OF THE INVENTION

In the above-mentioned drop cable, FRPs (Fiber Reinforced Plastics) are used for the strength members of the optical element portion in addition to the aforementioned steel wires. However, since this cable is made of conductive metal wires, induction at the time of lightning and induction from a power cable occur.

The study of yarn materials such as Kevlar (trade name), glass yarn, etc. as reasonable materials for making the strength members noninductive has been advanced.

However, in connection with this yarn, the shape of yarn material is not stable when the drop cable is subjected to extrusion forming. This is because the core portion and the yarn material come into contact with each other. When the core portion and the yarn material come into contact with each other, bending occurs in the core portion, and thus transmission loss is increased.

This invention is directed to a drop cable for making the strength members of the optical element portion noninductive. Moreover, this invention is directed to a method for fabricating a drop cable including strength members structured to reflect advantages of yarn.

The first aspect of the invention is directed to a method for fabricating a drop cable. The method includes the step of providing a strength member including a yarn including a non-conductive and tensile strength fiber. The method includes the step of arranging a core including an optical fiber side-by-side the strength member. The method includes the step of arranging a messenger wire side-by-side the core. The method includes the step of extruding the strength member, the core, and the messenger wire together for sheathing.

Preferably, the method includes the step of twisting the yarn for forming the strength member.

Preferably, the method includes the step of winding the yarn around a first axis. The method includes the step of rotating the wound yarn about a second axis crossing the first axis. The method includes the step of feeding the rotated yarn in a direction crossing the first axis.

Preferably, the method includes the step of winding the yarn around the first axis. The method includes the step of feeding the wound yarn in a direction of the first axis.

Preferably, the yarn is twisted at a pitch between 0.01 to 1 m.

Preferably, the method includes the step of applying a matrix resin to the yarn for forming the strength member. The method includes the step of heating the strength member during extrusion for setting the matrix resin.

Preferably, the fiber includes one of aramid fiber and glass fiber.

Preferably, the method includes the step of applying a sizing agent to the yarn for forming the strength member.

Preferably, the fiber includes one of aramid fiber and glass fiber.

Preferably, the sizing agent includes a thermoplastic resin.

Preferably, the resin includes one of epoxy, polyester, ethylene-acrylic, polyurethane and polyamide reins.

Preferably, the method includes the step of applying an absorbent material to non-conductive and tensile strength fibers. The method includes the step of bundling the applied fibers together with each other to form a strand as the strength member.

Preferably, the method includes the applied fibers are twisted together with each other to from the strand.

The second aspect of the invention is directed to a drop cable. The cable includes a messenger member. The cable includes a transmission member supported by the messenger wire. The transmission member includes a core including an optical fiber. The transmission member includes a strength member arranged side-by-side the core. The strength member includes a yarn including a non-conductive and tensile strength fiber.

Preferably, the strength member includes a sizing agent applied to the yarn.

Preferably, the fiber includes one of aramid fiber and glass fiber.

Preferably, the sizing agent includes a thermoplastic resin.

Preferably, the resin includes one of epoxy, polyester, ethylene-acrylic, polyurethane and polyamide reins.

Preferably, the yarn includes a water absorbent material applied to the fiber.

Preferably, the fiber includes one of aramid fiber and glass fiber.

Preferably, the water absorbent material includes acrylic fiber having a hydrophilic group incorporated thereinto.

Preferably, the yarn includes a strand of non-conductive fibers.

Preferably, strands are twisted together with each other.

### BRIEF DESCRIPTION OF THE DRAWINGS

FIG. 1 is an illustrative view of wiring of a cable;

FIG. 2 is a cross-sectional view of an optical fiber drop cable of FIG. 1;

FIG. 3 is a schematic view illustrating fabrication of an optical fiber drop cable according to the first embodiment;

FIG. 4 is a schematic view explaining a method for twisting yarn wound around a bobbin;

FIG. 5 is a schematic view illustrating another method for twisting yarn wound around a bobbin;

FIG. 6 is a cross-sectional view of the optical fiber drop cable according to the first embodiment;

FIG. 7 is a schematic view illustrating fabrication of an optical fiber drop cable according to the second embodiment;

FIG. 8 is a table showing evaluated properties of hot-melt adhesives;

FIG. 9 is a cross-sectional view of an optical fiber drop cable according to the fourth embodiment;

FIG. 10 is a side view of the cable of FIG. 9;

FIG. 11 is a schematic view illustrating an extruder for fabricating the cable of FIG. 9; and

FIG. 12 is a table showing evaluation items and conditions of the cable of FIG. 9.

### DETAILED DESCRIPTION OF THE PREFERRED EMBODIMENTS

Hereinafter, description will be made for embodiments of this invention will be made with reference to the drawings accompanying herewith.

First Embodiment

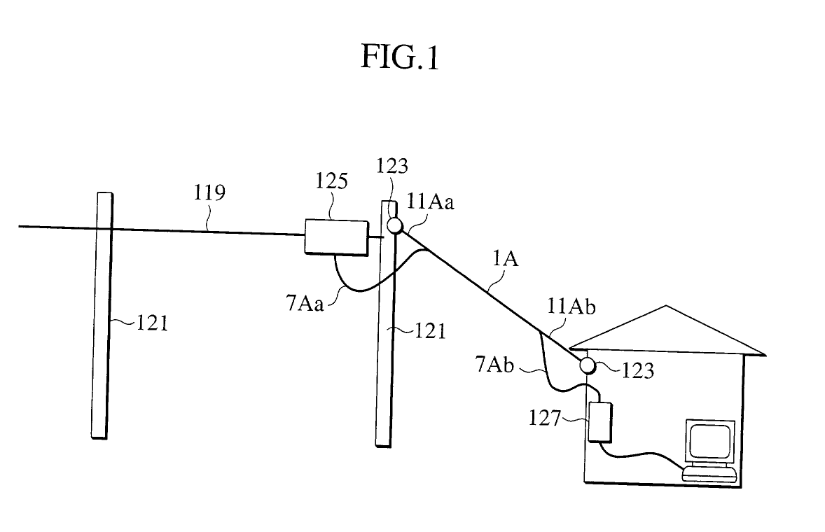

In FIG. 1, an optical fiber cable 119 is extended from a telephone office. In the case where an optical fiber core is dropped to each home, an optical fiber drop cable 1A is branched off from the cable 119. The cable 1A includes both ends, with a neck 9A partially cut off to separate an optical element portion 7A and a cable support portion 11A from each other. One end 11Aa of the support portion 11A is fixed to an outside wire fastening 123 on a utility pole 121. The other end 11Ab is fixed to a part of the house with the other fastening 123 interposed therebetween.

The optical element portion 7A has one end 7Aa connected to a cable branch closure 125 on the utility pole 121. The other end 7Ab is connected to an indoor OE converter or a termination box 127.

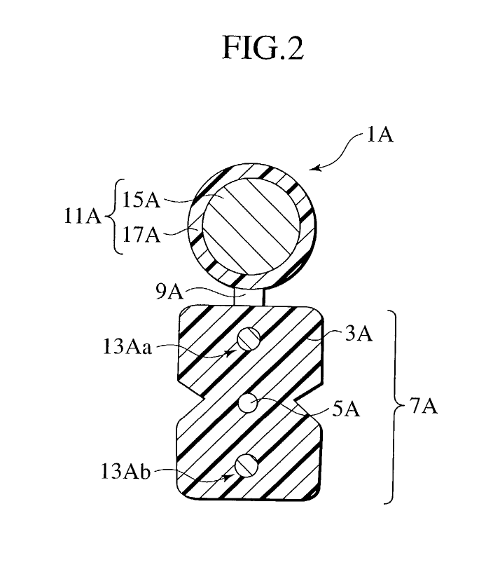

In FIG. 2, the cable 1A includes the long-size optical element portion 7A. The portion 7A has an optical fiber single core or an optical fiber tape core (hereinafter, they are generically referred to as a core 5A) buried in a sheath 3A. The cable 1A includes the long-size cable support portion 11A. The portion 11A is integrally fixed to the portion 7A parallel thereto on a continuous or spaced basis with the constricted neck 9A interposed therebetween.

In the optical element portion 7A, as first strength members, for example, at least a pair of twisted long-size yarns 13Aa and 13Ab (hereinafter referred to as 13A) are arranged parallel to each other, on the both sides relative to the core 5A therebetween. The yarns 13A are coated with the cable sheath 3A made of thermoplastic resin such as polyethylene and polyvinyl chloride (PVC) to form the portion 7A.

The support portion 11A and the portion 7A are integrally connected parallel to each other with the neck 9A interposed therebetween. In the portion 11A, a messenger wire 15A as a second strength member is coated with a sheath 17A made of thermoplastic resin. The messenger wire 15A is made of a metal wire, for example, a steel wire.

Next, description will be made for a fabricating method of the cable 1A.

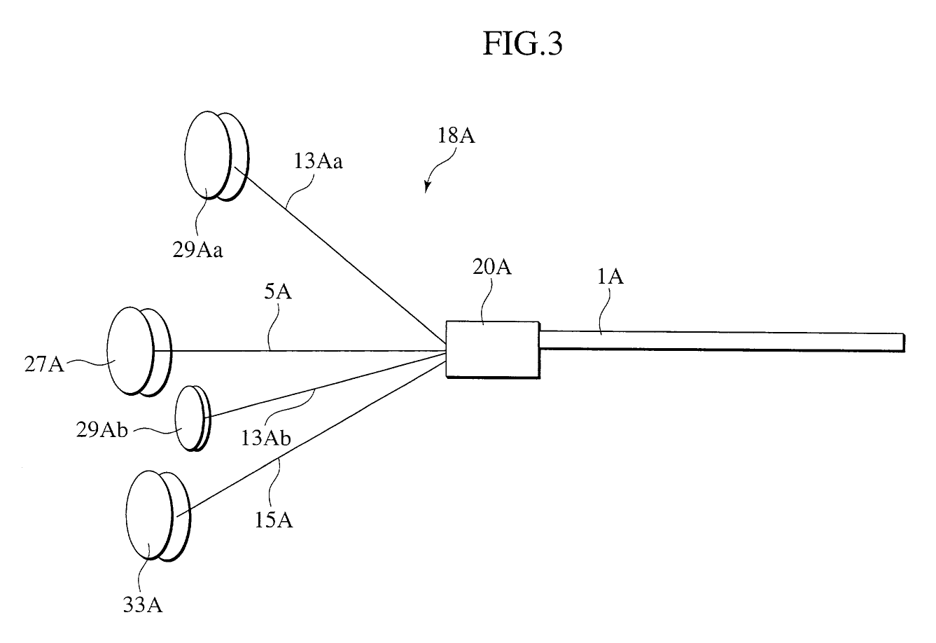

FIG. 3 illustrates an extruder 18A for forming the cable 1A.

Thermoplastic resin common to the sheaths 3A and 17A of the portions 7A and 11A is collectively extruded from an extruder head 20A as an extrusion mold to coat the core, the wire and the like therewith, and thus both of the portions 7A and 11A are integrally fixed to each other. When the core 5A and the yarn strength members 13A are coated with the sheath 3A, the messenger wire 15A is also coated with the sheath 17A in the mold. In this case, the extrusion forming of the cable 1A is carried out, and the existing facility can be used as it is.

According to the aforementioned constitution, the use of the first strength members 13A of the twisted yarns during extrusion forming gives the first strength members 13A properties that meet both bending rigidity and tensile strength. Since the first strength members 13A are made noninductive, it is possible to avoid induction at the time of lightning and induction from a power cable and to improve the bending rigidity and the tensile strength thereof. Moreover, since the shape of cross section in the cable 1A is stabilized, and no small bending occurs in the core 5A during the separation of the portions 7A and 11A from each other, transmission loss is stabilized.

The improved bending rigidity and tensile strength allow no small bending in the core 5A during the separation of the portions 7A and 11A from each other, thus stabilizing the transmission loss. Moreover, since the first strength members 13A are made noninductive, it is possible to avoid the induction at the time of lightning and the induction from the power cable.

During the wiring of the aforementioned cable 1A, the cable 1A is wired between the subscriber's house and the cable branch closure 125 attached to the end of the optical fiber cable 119 extended from the telephone office and placed on the utility pole, so that the optical fiber is dropped to the home from the cable 119.

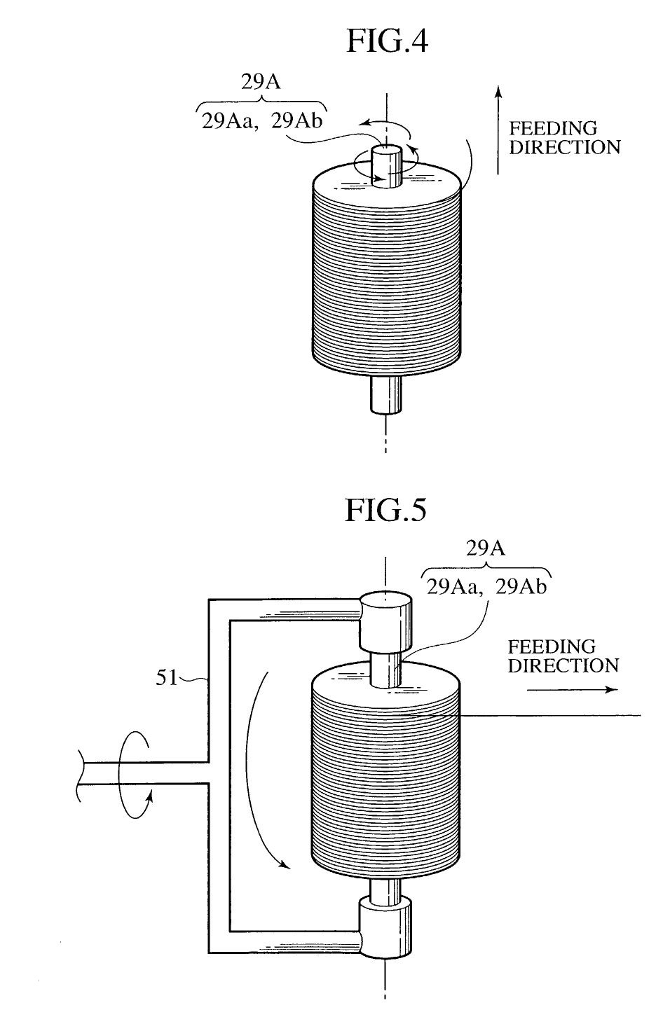

Means for twisting the yarns 13A is illustrated in FIG. 4. Bobbins 29Aa and 29Ab (hereinafter referred to as 29A) have yarns 13A wound around them. With bobbins 29A set in an upright state. The yarns 13Aa and 13Ab are fed to an axial direction of the bobbins 29A, thus making it possible to twist the yarns 13A.

Moreover, another means for twisting the yarns 13Aa and 13Ab is illustrated in FIG. 5. While the bobbins 29Aa and 29Ab, around which the yarns 13Aa and 13Ab are wound, are being rotated by joint 51 about an axis perpendicular to the axial direction as shown by the arrow, the yarns 13A are fed to a direction perpendicular to the axial direction of the bobbins 29A, thus making it possible to twist the yarns 13A.

As described above, with the bobbins 29A having the yarns 13A wound around being set in the upright state, the yarns 13A are fed to the axial direction of the bobbins 29A. Alternatively, the yarns 13A are fed to the direction perpendicular to the axial direction of the bobbins 29A while the bobbins 29A are being rotated about the axis perpendicular to the axial direction. Accordingly, it is made possible to provide a necessary twist to the yarns 13A simply and easily.

The winding pitch of the yarns 13A is desirably 10 mm to 1000 mm in terms of the point that high efficient extrusion is carried out to meet both of the bending rigidity and the tensile strength. If the pitch is preferably set to 100 mm to 500 mm, the optical fiber drop cable 1 can be fabricated with high productivity without breaking up the yarns 13A. If the yarn pitch becomes longer than the above, no twist effect is produced, and if the pitch becomes shorter, productivity deteriorates.

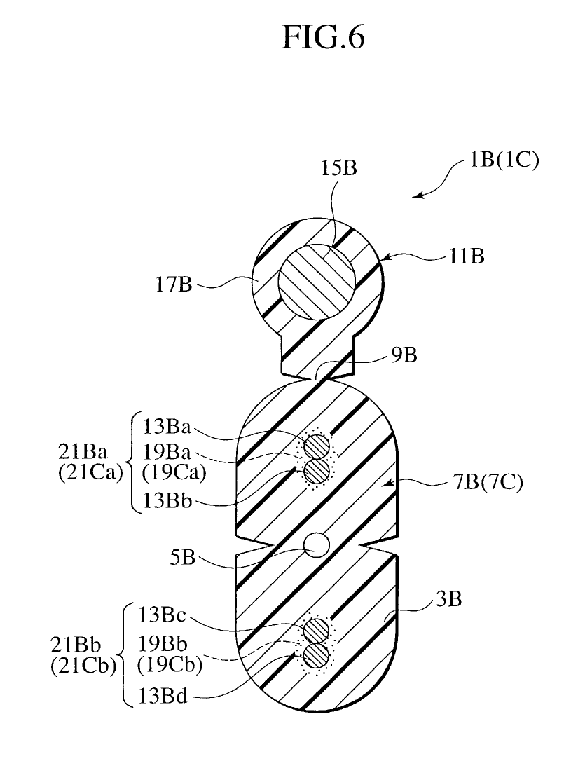

In FIG. 6, in an optical element portion 7B, as first strength members, for example, at least a pair of long-size FRPs (Fiber Reinforced Plastic) 21a and 21b (hereinafter referred to as 21) are arranged parallel to each other, on the both sides relative to an optical fiber core 5B therebetween. The FRPs 21 include yarns 13Ba, 13Bb, 13Bc and 13Bd (hereinafter referred to as 13B), for example, Kevlar (trade name) as a plurality of aramid fibers, glass yarns, and the like. The FRPs 21 include matrix resin 19Ba and 19Bb (hereinafter referred to as 19B), which are applied to the yarns 13B. They are coated with the sheath 3 made of thermoplastic resin such as polyethylene and polyvinyl chloride (PVC) to form the portion 7B.

Next, description will be made for a fabricating method of the cable 1B.

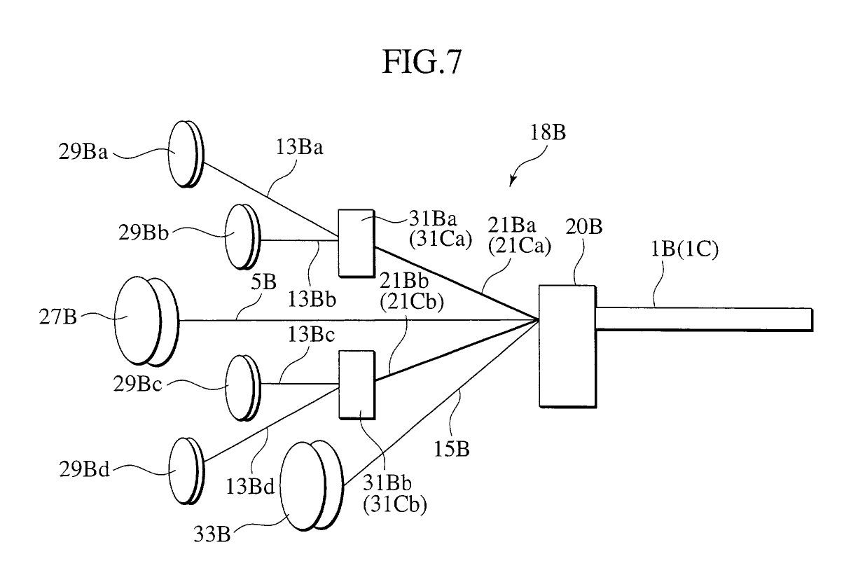

FIG. 7 shows an extruder 18B for forming the cable 1B. Thermoplastic resin common to sheaths 3B and 17B of portions 7B and 11B is collectively extruded from an extruder head 20B as an extrusion mold of extruder 18B to coat the core, the wire and the like therewith. The both of the portions 7B and 11B are integrally fixed to each other.

The core 5B is fed from a bobbin 27B. The plurality of yarns 13B are fed from the bobbins 29B. The yarns 13B are coated with the resin 19B by coating devices 31Ba and 31Bb upstream of the extruder head 20B to form the FRPs 21B. In this state, the FRPs 21B are cured by heat generated when the cable 1B is subjected to the extrusion forming by the extrusion head 20B. The FRPs 21B are coated with the sheath 3B during the passage through the extrusion head 20B to be formed into the first strength member. Meanwhile, a messenger wire 15B is fed from a bobbin 33B. Similarly, the messenger wire 15B is coated with the sheath 17B in the extrusion head 20B. In this case, the sheaths 3B and 17B are a common sheath.

In connection with the FRPs 21B as the first strength members of the portion 7B, resin 19B is applied to the yarns 13B, for example, Kevlar (trade name) as a plurality of aramid fibers, glass yarns, and the like. As shown in FIG. 7, the extrusion of the cable 1B is performed as in the conventional manner except the setting of the coating devices 31B, and the existing facility can be used as it is.

According to the aforementioned constitution, when the cable 1B is formed by extrusion, the resin 19B is applied to the yarns 13B to form the FRPs 21B as the first strength members. By this coating, it is possible to provide the first strength members with the properties that meet both of the bending rigidity and the tensile strength. The first strength members (RFPs) 21B of the portion 7B are made noninductive, and it is possible to avoid the induction at the time of lightning and the induction from the power cable. The FRPs 21B improve the cable 1B in connection with the bending rigidity and the tensile strength. The FRPs 21B stabilize the shape of cross section in the cable 1B, and generate no small bending in the core 5B at the time of separating the support portion 11B and the element portion 7B from each other. This allows the transmission loss to be stabilized. The cable 1B can be simply and easily fabricated at low cost.

Third Embodiment

This embodiment has an optical fiber drop cable 1C, which is identical to that of FIG. 6 except the following points.

In an optical element portion 7C, as first strength members, at least a pair of long-size strength members 21Ca and 21Cb (hereinafter referred to as 21C) are arranged parallel to each other on both sides thereof relative to the optical fiber core 5B therebetween. The strength members 21C include the yarns 13B, for example, Kevlar (trade name) as a plurality of aramid fibers, glass yarns, and the like. The strength members 21C include hot-melt adhesives 19Ca and 19Cb (hereinafter referred to as 19C) as sizing agent, which are applied to the yarns 13B. They are coated with the sheath 3 made of thermoplastic resin such as polyethylene and polyvinyl chloride (PVC) to form the portion 7C.

Next, description will be made for a fabricating method of the above optical fiber drop cable 1C.

In FIG. 7, the core 5B is fed from the bobbin 27B. The plurality of yarns 13B is fed from the bobbins 29B. The yarns 13B are coated with the hot-melt adhesives 19C as sizing agent by, for example, adhesive tanks 31Ca and 31Cb (hereinafter referred to as 31C) as coating devices upstream of the extruder head 20B. In this state, the strength members 21C are closely adhered to the sheath 3B as extrusion resin to be coated therewith under heat. The heat is generated during later sheathing when the cable 1C is subjected to the extrusion forming by the extruder head 20B. Thus, adhesion strength between the yarns 13B and the resin increases.

According to the aforementioned constitution, when the cable 1C is formed by extrusion, the hot-melt adhesives 19C are applied to the yarns 13B to form the strength members 21C. By this coating, it is possible to provide the first strength members with the properties that meet both of the bending rigidity and the tensile strength. The first strength members of the portion 7C are made noninductive, and it is possible to avoid the induction at the time of lightning and the induction from the power cable. The strength members 21C improve the bending rigidity and the tensile strength thereof. The strength members 21C can stabilize the shape of cross section in the cable. The strength members 21C produce no small bending in the optical fiber core 5 when the cable messenger wire portion and the optical element portion are separated from each other. This allows the transmission loss to be stabilized. The cable 1C can be simply and easily fabricated at low cost.

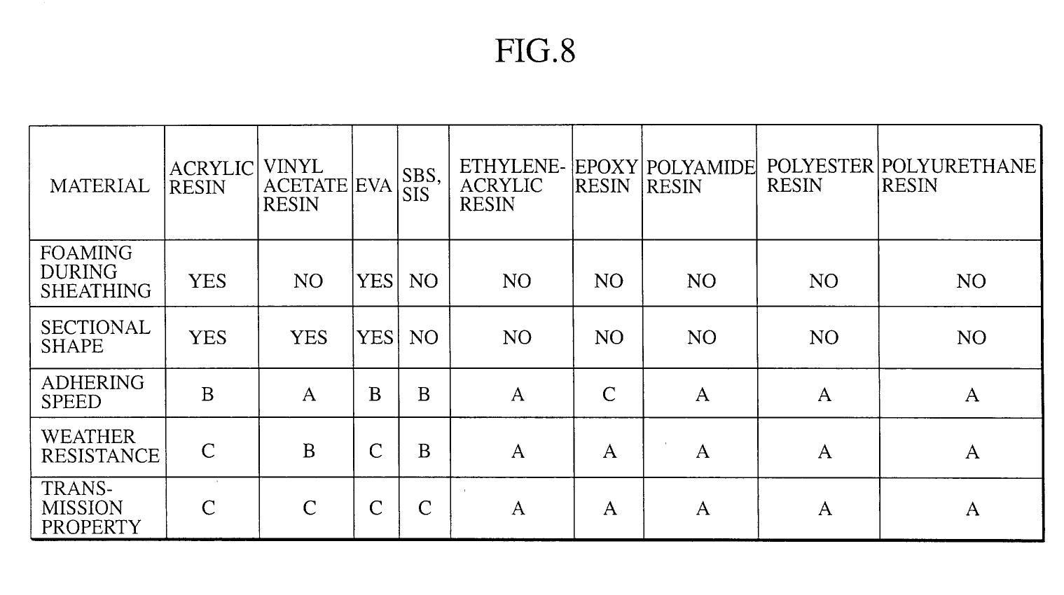

In the fabricating method of the above optical fiber drop cable 1C, as shown in FIG. 8, there was obtained a property result using various kinds of resin as adhesives 19C. The resin includes acrylic, vinyl acetate, ethylene-vinyl acetate (EVA), styrene-butadiene-styrene (SBS), styrene-isoprene-styrene (SIS), ethylene-acrylic, epoxy resin, polyamide, polyester, and polyurethane.

In FIG. 8, with regard to foaming during sheathing, the resin is represented as “Yes”, which produces foaming assumed to be caused by volatilization of the sizing agent during sheathing, and otherwise, represented as “No”.

With regard to the shape of cross section, the resin is represented as “Yes”, which has the yarn portion and the core portion in contact with each other after the disassembly of the cable, and otherwise, represented as “No”.

With regard to adhesion speed, the resin is represented as “C”, which has time for the completion of adhesion within a range of minute to hour. The resin is represented as “B”, which has the time is within a range of minute. The resin is represented as A, which has the time within a range of second.

With regard to weather resistance, The resin is represented as “C”, which is not excellent in either low-temperature or high-temperature resistance. The resin is represented as “B”, which is excellent in either one of them. The resin is represented as “A”, which is excellent in both of them.

With regard to transmission property, the transmission loss is measured using an ORDR (optical time domain reflectometer) with a wavelength of 1.55 im. The resin is represented as C, with the transmission loss of more than 0.30 dB/km. The resin is represented as “B”, with the transmission loss of 0.25 to 0.30 dB/km. The resin is represented as “A”, with the transmission loss of equal to or less than 0.25 dB/km.

From results of the above, it was understood that the use of epoxy resin, polyester resin, ethylene-acrylic resin, polyurethane resin or polyamide resin was preferable as hot-melt resin.

Fourth Embodiment

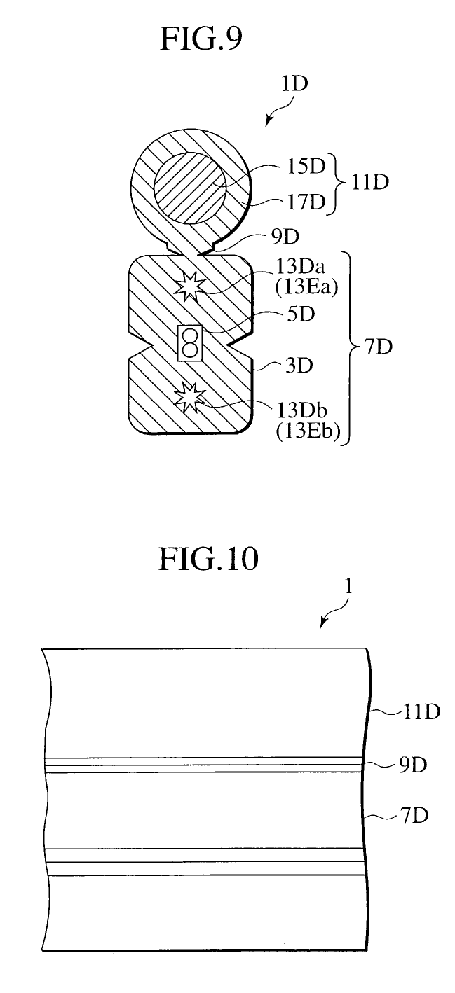

In FIG. 9, this optical fiber drop cable 1D includes an optical fiber tape core 5D (or optical fiber core). The first strength members are made of a pair of insulating tensile strength fibers (hereinafter simply referred to as strength members 1D). The strength members 11D are arranged on both sides relative to the core 5D. In the cable 1D, an optical element portion 7D is integrally fixed to a cable support portion 11D on a continuous or spaced basis to be parallel thereto with a constricted neck 9D interposed therebetween. The portion 7D is coated with a sheath 7 made of thermoplastic resin. The portion 11D is formed by coating sheath 17D of a thermoplastic resin on second strength members (hereinafter referred to as a messenger wire 15D) made of, for example, steel wires.

Insulating tensile strength fibers used as strength members 13Da and 13Db (hereinafter referred to as 13D) are, for example, glass fibers and aramid fibers. These fibers as an assembly are bundled to form strength members 13D of about 1500 deniers.

The glass fibers can be largely divided into two kinds, that is, a continuous fiber and a discontinuous fiber. The continuous fiber used in the cable or the like is generally called glass yarn 41. This yarn 41 has good dimensional stability with very little expansion and contraction in addition to tensile strength equivalent to special steel. The yarn 41 has a characteristic being a noncombustible fiber with extremely high electrical insulation and high heat resistance.

For the aramid fibers, for example, Kevlar (trademark registered by DuPont) is used. Kevlar has tensile strength of 300 kg/mm² and good dimensional stability with little expansion and contraction. Kevlar has a characteristic being a noncombustible fiber excellent in heat resistance and impact resistance.

As an absorbent material applied to the strength members 5D, there is used water-absorbent powder generated by introducing a hydrophilic group into an acrylic fiber. The absorbent powder is a powder material whose absorptivity to water is extremely good. This powder is produced by pulverizing a certain fiber. Chemical treatment is provided to a chain carbon atom (chain compound) forming an acrylic fiber. A hydrophilic group having a high affinity for water (for example, hydroxyl group (—OH), carboxyl group (—COOH), amino group (—NH2)) is composed in a side chain branched off from the carbon atom. Thus, the fiber is produced.

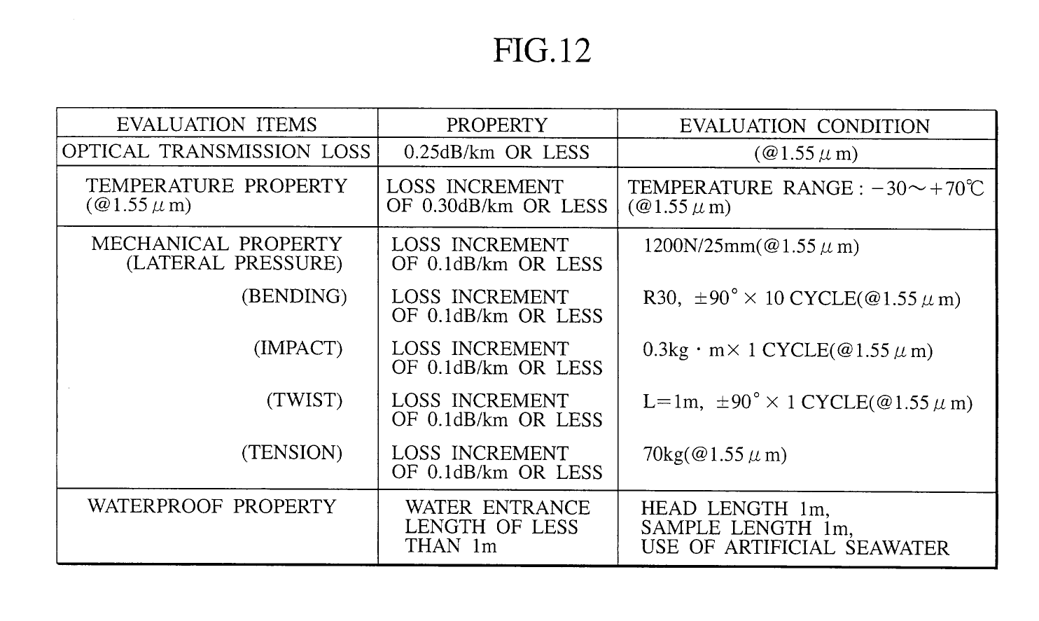

Next, description will be made for a fabricating method of the cable 1D. FIG. 12 is a view illustrating the outline of an extruder 18D for fabricating the cable 1D of the present invention. Additionally, in this embodiment, glass yarns 14 are used as strength members 13D.

The extruder 18D includes bobbins 29Da, 29Db, 29Dc and 29Dd (hereinafter referred to as 29D) around each of which the glass yarn 41 is wound. The extruder 18D includes absorbent material coating devices 31Da and 31Db (hereinafter referred to as 31D). The extruder 18D includes bobbins 27D around each of which the tape core 5D is wound. The extruder 18D includes a bobbin 33D around which the messenger wire 15D is wound. The extruder 18D has an extruder head 20D. The extruder head 20D collectively coats, with thermoplastic resin, the strength members 13D, the tape core 5D, and the messenger wire 15D, which are formed by the coating devices 31D.

The coating devices 31D have injection nozzles for injecting water-absorbing powder uniformly. The coating devices 31D apply water-absorbing powder to the entire surface of glass yarns 41 uniformly, and bundle and cure the plurality of glass yarns 41.

The extruder head 20D includes a mold presser therein. When the strength members 13D, the tape core 5D and the messenger wire 15D are passed through the mold presser, the strength members 13D are arranged to sandwich the tape core 5D therebetween on both sides thereof. The extruder head 20D coats them with the sheath 3D of thermoplastic resin to form the portion 7D. Meanwhile, the messenger wire 15D is also coated with the sheath 17D made of thermoplastic resin to form the support portion 11D. Both portions are collectively extruded and integrally adhered to each other with the neck 9D interposed therebetween.

Therefore, according to the above-mentioned fabricating method, the strength members 13D are coated with the water-absorbing powder and bundled. The strength members 13D are sheathed together with the tape core 5D and the messenger wire 15D in the extruder head 20D, and thus can be fabricated in a long-sized shape. Even if water enters the strength members 13D, the water-absorbing powder absorbs water to suppress water entrance speed thereto.

Next, description will be made for evaluation of the cable 1D fabricated by the above method with reference to FIG. 12.

In the optical fiber drop cable 1D used in the evaluation, the strength members 13D have a wire diameter of about 0.4φ, tensile strength of about 95 N, and a tensile elasticity modulus of 26000 N/mm². A measured wavelength of 1. 55 μm, which is employed in a relay network system, is used.

As shown in FIG. 12, evaluation items include four items of optical transmission loss, temperature property, mechanical property, and waterproof property. In connection with the mechanical property, lateral pressure property, bending property, impact property, twist property, and tension property are measured.

In connection with the evaluation of the optical transmission loss, the amount of power lost in the optical fiber per unit length of the cable 1D is measured based on a ratio of power from incident light to one from emitted light. The optical transmission loss equal to or less than 0.25 dB/km is regarded as acceptable.

In connection with the evaluation of the temperature property, the optical transmission loss is measured in the range of −30° C. to +70° C. with consideration given to the wiring environments of the cable 1D. A heat cycle is performed in the temperature range of −30° C. to +70° C. Consequently, the increasing amount of loss equal to/less than 0.3 dB/km with a test start time set as 0 is regarded as acceptable.

In connection with the evaluation of the lateral pressure, an increase in the generated optical transmission loss is measured when pressure of 1200 N/25 mm² is applied from the side surface of the cable 1D thereto. The resultant value equal to or less than 0.1 dB is regarded as acceptable.

In connection with the evaluation of the bending property, an increase in the generated optical transmission loss is measured when a ±90° angle bending with a radius of 30 m is added to the cable 1D for 10 cycles is measured. Then, the resultant value equal to or less than 0.1 dB is regarded as acceptable.

In connection with the evaluation of the impact property, both ends of the cable 1D are fixed by fixing brackets. An increase in the generated optical transmission loss is measured when a twist is applied to the cable 1D (one time/m) and stress of 0.3 kg is applied thereto. Then, the resultant value equal to or less than 0.1 dB is regarded as acceptable.

In connection with the evaluation of the twist property, both ends of the cable 1D are fixed by the fixing brackets. An increase in the generated optical transmission loss is measured when a twist is applied to the cable 1D (one time/m) and a twisting direction (angle) is set to ±90°. Then, the resultant value equal to or less than 0.1 dB is regarded as good.

In connection with the evaluation of the tension property, an increase in the generated optical transmission loss is measured when tensile strength of 70 kg/m is added to the cable 1D. Then, the resultant value is equal to or less than 0.1 dB is regarded as acceptable.

In connection with the evaluation of the waterproof property, the cable 1D with a water head length of 1 m and a sample length of 1 m is soaked in artificial seawater for 168 hours. Then, a distance from the end of the cable 1D where water has entered to a position where the water has reached is measured under this condition.

It was confirmed by the aforementioned evaluation method that the cable 1D had the properties with no practical difficulty as a result of performing the evaluation based on the respective conditions.

More specifically, the optical transmission loss is equal to or less than 0.25 dB/km and the temperature property is equal to or less than 0.30 dB/km. Generally, there is no trouble in transmission if these values are equal to or less than 0.5 dB/km. Accordingly, the sufficient optical transmission loss property within the temperature range of −30° C. to +70° C. was confirmed from these values.

In the mechanical property, the evaluation result of the measured lateral pressure is equal to or less than 0.1 dB, and the bending property, the impact property, the twist property, and the tension property are also equal to or less than 0.1 dB. Accordingly, in the case of using the cable 1D in the wiring construction or ground wiring, it was confirmed that the cable 1D was able to be used normally under either of these environments.

Moreover, in the waterproof property, the water entrance length was 19 m in a state where no water-absorbent material was applied to the cable. However, coating of the water-absorbent material led to the result that the water entrance length was less than 1 m.

Accordingly, from the measurement result based on the evaluation conditions of FIG. 12, this cable suppresses the increase in the transmission loss due to external force under circumstances where aerial setting for suspending the cable and ground wiring for burying the cable in the ground are carried out.

Moreover, even if a crack occurs on the sheath 3D of the cable 1D and water infiltrates therethrough, the water-absorbent material applied to the strength members 13D absorbs water. Accordingly, this cable 1D suppresses rapid water entrance, gains time until the construction for cable replacement, and can carry out normal transmission until the cable replacement.

Similarly, even if water enters the aerial closure provided outdoors and water infiltrates the cable 1D through a fracture surface thereof, the water-absorbent material applied to the strength members 13D absorbs water, and suppresses rapid water entrance in a gap portion. This suppression of water entrance allows normal transmission to be carried out until the cable replacement.

Fifth Embodiment

In the strength members 3D of the fourth embodiment described above, the required number of insulating fibers are bundled to form the assembly of equal to or more than 1000 deniers to equal to or less than 2000 deniers. Meanwhile, the constitution of the strength members 13E is not limited to this, and the assembly of insulating fibers may be twisted.

At this time, a filling factor of strength members 13E is desirably equal to or more than 50%. This is because the following fact can be obtained by measurement. Namely, at the time of tearing up the portions 7D and 1D, if the filling factor is equal to or more than 50%, tension applied to the core 5D becomes small, so that a break in the core 5D and an increase in transmission loss thereof are less prone to occur.

Additionally, the filling factor described here means an occupation ratio of the twisted insulating fibers relative to the cross-sectional area of the gap where the strength members 13E enter.

Moreover, in the case where the assembly of insulating fibers is equal to or more than 1000 deniers to equal to or less than 2000 deniers and the filling factor is equal to or more than 50%, Young's modulus of 7000 kgf/mm² can be obtained. The strength members 13E, which are bundled and twisted, suppress against water entrance thereinto. Suppression of the water entrance prevents the increase in transmission loss and spread of the insulating fibers, which is produced at the time of coating. Accordingly, it is possible to provide an optical fiber drop cable having high rigidity as compared with the non-twisted strength members.

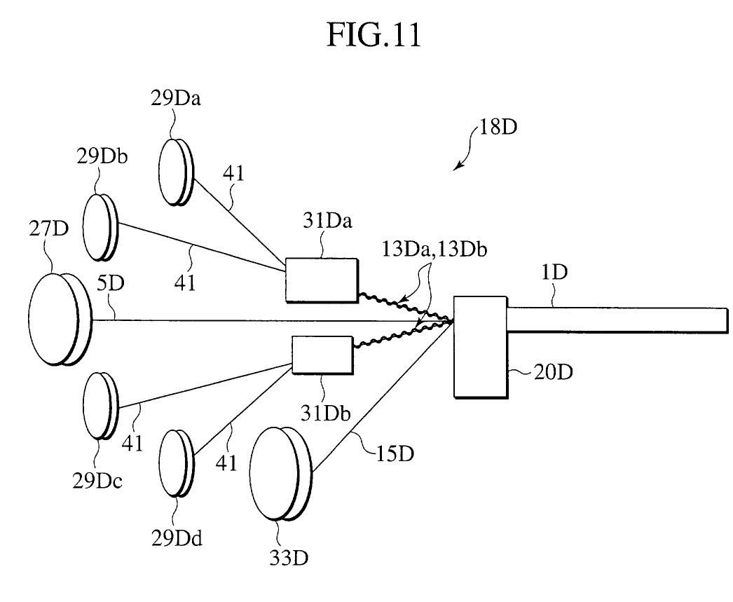

Additionally, the fabricating method in which a twist is applied to the insulating fibers can be achieved in such a manner that the glass yarn 41 of FIG. 11, which is wound around the bobbin 29D, and the glass yarn 41, which is wound around the other bobbin 29D, are twisted each other while the bobbins 29D rotating themselves.

The twisting strength can be easily set by adjusting the rotation speed of the bobbins 29D and the feeding speed of the yarns 41. After twisting the yarns, absorbent material is uniformly applied thereto from the injection nozzle in the absorbent material coating devices 31D. After curing the yarns, the resultant is fed to the extruder head 20D.

Accordingly, even if the insulating fibers are twisted to form the strength wires 13E, similarly to the above-described embodiments, water-absorbing powder, which is applied to the strength members 13E, absorbs water even in the case where a crack occurs on the sheath 3D and water infiltrates therethrough and even in the case where water enters the aerial closure and water infiltrates the optical fiber drop cable through a fracture surface thereof. Therefore, it is possible to suppress rapid water entrance and to carry out normal transmission until the cable replacement.

The entire contents of Japanese Patent Applications P2001-376977 (filed Dec. 11, 2001), P2001-315648 (filed Oct. 12, 2001), P2001-320452 (filed Oct. 18, 2001), and P2001-325513 (filed Oct. 23, 2001) are incorporated herein by reference.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. A method for fabricating a drop cable, comprising:
providing a strength member including a yarn including a non-conductive and tensile strength fiber;
arranging a core including an optical fiber side-by-side the strength member;
arranging a messenger wire side-by-side the core; and
extruding the strength member, the core, and the messenger wire together for sheathing.

2. The method according to claim 1, further comprising:
twisting the yarn for forming the strength member.

3. The method according to claim 2, further comprising:
winding the yarn around a first axis;
rotating the wound yarn about a second axis crossing the first axis; and
feeding the rotated yarn in a direction crossing the first axis.

4. The method according to claim 2, further comprising:
winding the yarn around the first axis; and
feeding the wound yarn in a direction of the first axis.

5. The method according to claim 2,
wherein the yarn is twisted at a pitch between 0.01 to 1 m.

6. The method according to claim 1, further comprising:
applying a matrix resin to the yarn for forming the strength member;
heating the strength member during extrusion for setting the matrix resin.

7. The method according to claim 6,
wherein the fiber includes one of aramid fiber and glass fiber.

8. The method according to claim 1, further comprising:
applying a sizing agent to the yarn for forming the strength member.

9. The method according to claim 8,
wherein the fiber includes one of aramid fiber and glass fiber.

10. The method according to claim 8,
wherein the sizing agent includes a thermoplastic resin.

11. The method according to claim 10,
wherein the resin includes one of epoxy, polyester, ethylene-acrylic, polyurethane and polyamide reins.

12. The method according to claim 1, further comprising:
applying an absorbent material to non-conductive and tensile strength fibers; and
bundling the applied fibers together with each other to form a strand as the strength member.

13. The method according to claim 12,
wherein the applied fibers are twisted together with each other to from the strand.

14. A drop cable comprising:
a messenger member;
a transmission member supported by the messenger wire;
the transmission member comprising:
a core including an optical fiber; and
a strength member arranged side-by-side the core, the strength member including a yarn including a nonconductive and tensile strength fiber.

15. The drop cable according to claim 14,
wherein the strength member includes a sizing agent applied to the yarn.

16. The drop cable according to claim 14,
wherein the fiber includes one of aramid fiber and glass fiber.

17. The drop cable according to claim 15,
wherein the sizing agent includes a thermoplastic resin.

18. The drop cable according to claim 17,
wherein the resin includes one of epoxy, polyester, ethylene-acrylic, polyurethane and polyamide reins.

19. The drop cable according to claim 14,
wherein the yarn includes a water absorbent material applied to the fiber.

20. The drop cable according to claim 19,
wherein the fiber includes one of aramid fiber and glass fiber.

21. The drop cable according to claim 19,
wherein the water absorbent material includes acrylic fiber having a hydrophilic group incorporated thereinto.

22. The drop cable according to claim 19,
wherein the yarn includes a strand of non-conductive fibers.

23. The drop cable according to claim 22,
wherein strands are twisted together with each other.
